(19) United States
(12) Patent Application Publication
(10) Pub. No.: US 2012/0299210 A1
(43) Pub. Date: Nov. 29, 2012

(54) PLANT FOR THE CONTINUOUS MANUFACTURE OF AN EXPANDABLE PLASTIC GRANULATE AS WELL AS METHOD FOR PRODUCING IT

(75) Inventor: Philip Nising, Oetwil am See (CH)

(73) Assignee: Sulzer Chemtech AG, Winterthur (CH)

(21) Appl. No.: 13/575,937

(22) PCT Filed: Jan. 11, 2011
(86) PCT No.: PCT/EP2011/050274

§ 371 Date: Jul. 27, 2012

(30) Foreign Application Priority Data
Jan. 28, 2010 (EP) 10151999.9

(51) Int. Cl. B28B 11/14; B29B 9/06

(52) U.S. Cl. 264/143; 425/305.1

(57) ABSTRACT

A plant (1) for the continuous manufacture of an expandable plastic granulate (G) is disclosed that includes a plastic melt source (2) for providing a plastic melt (F), an impregnating device (3) for providing an impregnated plastic melt (FB) by impregnating the plastic melt (F) with an expanding agent (B) provided by an expanding agent source, and a granulator (4, 41, 42) for producing the granulate (G) from the impregnated plastic melt (FB) with the granulator (4, 41, 42), with the granulator (4, 41, 42) being fluidly connected to the impregnating device (3). According to the invention, a switching means (5) is provided in such a way, that the plastic melt (F) can be fed to the granulator (4, 41, 42) under bypassing the impregnating device (3). In addition, the invention relates to a method for producing a granulate (G) using a plant (1) in accordance with the invention.

The invention relates to a plant for the continuous manufacture of expandable plastic granulate as well as to a method for producing an expandable plastic granulate in accordance with the pre-characterising part of the independent claim of the respective category.

A method and also a plant for the manufacture of expandable plastic granulate is well known from the art, for example from EP 0 668 139 A1. Regarding a special example of the method according to EP 0 688 139 A1 an impregnated polymer melt is made into pieces in an underwater granulator by means of a shape giving solidification. The melt is extruded through nozzles; the strands which are formed in this way are quenched with water and brought into granulate form by comminution with rotating knives. In this method the polymer melt is pre-cooled prior to entry into the granulator in order to avoid expansion of the strands during extrusion. The provision made for cooling of the impregnated melt to a temperature which lies a few degrees C. above the solidification temperature of the melt is problematic. This is because it is very difficult under circumstances such as these to allow the same quantity of melt to flow through all the extrusion nozzles of the granulator which are arranged in parallel. Instabilities in the melt flow arise which can lead to the closing of individual nozzles by the melt solidifying in them.

Meanwhile, these problems have been partly solved by the invention according to EP 1 702 738 A2 allowing expandable plastic granulate to be manufactured continuously, with a plastic melt being impregnated using a fluid expanding agent and the impregnated melt being granulated. The method in accordance with EP 1 702 738 A2 is carried out by means of a plant, which includes the following components: at least one pressure producing feed apparatus for the melt, which can be in particular a volumetrically pumping feed apparatus, a metering apparatus for the expanding agent, a contacting and homogenising apparatus for the impregnation of the melt, at least one cooler for the impregnated melt, an underwater granulator and a plant control unit.

The granulation is carried out using a liquid which is used in the granulator as a cooling and transport medium for the granulate. The liquid is in particular water or a brine (or a sols). An elevated pressure is applied with the liquid used during granulation, due to which an expanding action of the expanding agent in the not yet solidified granulate is at least partly suppressed. A regulation of the parameters to be adjusted for the granulation, namely the temperature and pressure of the impregnated melt is effected at the inlet of the granulator. In this regulation, measurements of the named parameters are made and also measurement values are compared with desired values and deviations from the desired values are used by the plant control to influence a heat take-up from the impregnated melt by the cooler or coolers.

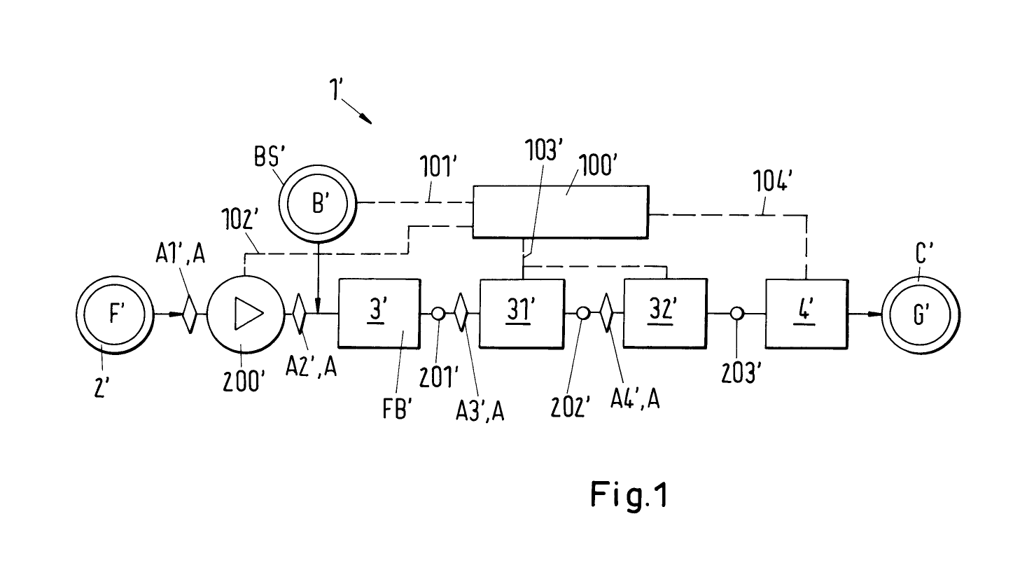

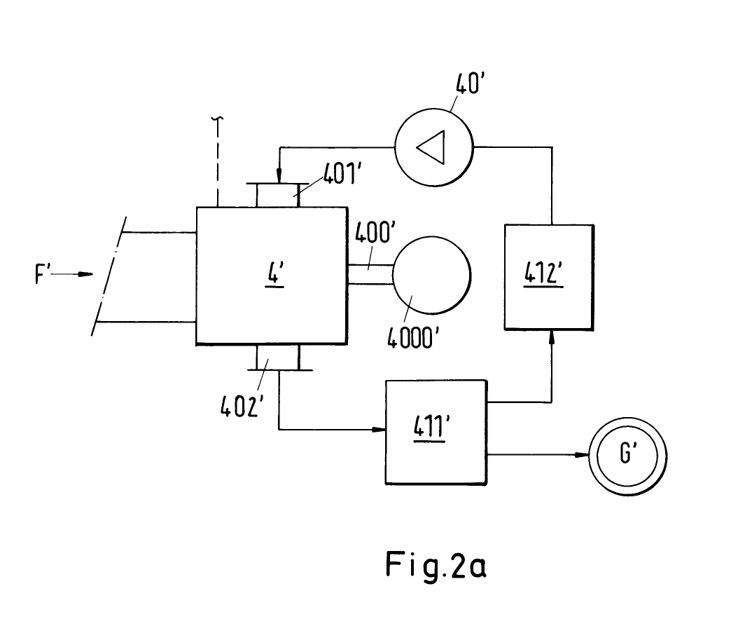

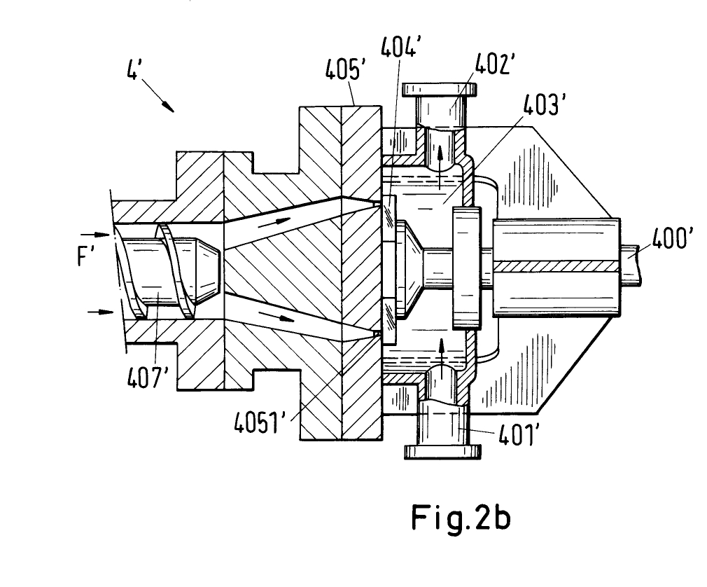

Since the present invention relates to an improved apparatus as well as to an improved method for manufacturing expandable plastic granulates, for a better understanding of the invention and a more clearly delineation from the prior art, a respective state of the art and problems related therewith shall be briefly explained in the following with the help of FIG. 1 and FIG. 2. FIG. 1 showing a schematic example of a well known plant for manufacturing expandable plastic granulates, wherein with the help of the schematic FIG. 2 the basic principle of a well known underwater granulator is explained in order to demonstrate its function in more detail.

Please note that in the present specification for the delineation of the prior art from the present invention, those features which relate to a plant or to components of a plant known from the prior art are provided with a dash, whereas the features in accordance with the invention are designated by reference numerals without a dash.

A well known method for the continuous manufacture of expandable plastic granulates G′ is till this date carried out by using for example a plant 1′ as schematically illustrated in FIG. 1. In this arrangement a plastic melt F′ is impregnated with a fluid expanding agent B′ and the melt F′ which has been treated in this manner is finally granulated. The plant 1′ includes in this particular example the following components: one pressure producing feed apparatus 200′ with which the melt F′ obtained from a plastic source 2′ is volumetrically fed; a source BS′ for the expanding agent B′, which is fed to the melt F′ using a metering apparatus; a contacting and homogenising apparatus 3′ for the impregnation of the melt F′; at least one cooler 31′ for the impregnated melt FB′; a further homogenising apparatus 32′ which is optional; an underwater granulator 4′; and also a plant control 100′. The granulate G′ which has been produced is ultimately available as a product in a container C′.

The plastic source 2′ can consist of a polymerisation reactor for the manufacture of the plastic from a monomer source material and also a degasification apparatus for the polymer. The plastic source 2′ can also be a recycling apparatus for recycled thermoplastic of one type and also includes a melting apparatus, in particular a heatable extruder. The plastic source 2′ can also simply be a melting apparatus in which a granular thermoplastic is liquefied.

The granulation is carried out using a liquid, preferably water, for example also a brine or a sols, which is used in the granulator 4′ as a cooling and transport medium for the granulate G′. An elevated pressure is exerted with the liquid used during granulation, due to which an inflating action of the expanding agent B′ in the not yet solidified granules is suppressed, at least in part.

A regulation of the parameters to be adjusted for the granulation at the inlet of the granulator 4′, namely the temperature and the pressure of the impregnated melt, is effected using the plant control 100′. In this regulation measurements of the named parameters are made and also measurement values are compared with desired values. Deviations from the desired values are used to influence a heat take-up from the impregnated melt by the cooler or coolers 31′, 32′.

The parameters to be adjusted for the granulation are regulated with electronic means using the plant control 100′. These means have signal-transmitting connections 101′, 102′, 103′ and 104′ to the expanding agent source BS′, to the feed apparatus 200′, to the cooler 31′, or to a plurality of coolers 31′, 32′ and to the granulator 4′, respectively.

The following adjustable parameters are relevant for the impregnation: temperature, pressure and dwell time. The required dwell time depends on the amount of expanding agent B′ provided for impregnation. A fixed ratio of expanding agent flow to melt flow is set by means of the plant control for each pre-determined proportion of expanding agent B′. These flows, which can be variable, are produced by volumetric feeding. The parameters temperature and pressure at the inlet of the granulator 4′ are relevant for the granulation.

At least one additive A′ can be added before, during and/or after the impregnation of the melt F′. Points for the feeding in of additives A′ are shown by FIG. 1 with rhombuses A1′, A2′, A3′ and A4′.

The feed apparatus 200′ is advantageously a gear pump, however it can also be an extruder. Further feed apparatuses (pumps, extruders, screw conveyers) can be used in the plant in accordance with the invention. Possible points for additional feed apparatuses are shown in FIG. 1 as small circles 201′, 202′ and 203′.

Please note that any single component of a plant 1′ as describe above, in particular for example the plastic source 2′, the pressure producing feed apparatus 200′, the homogenising apparatus 3, the coolers 31′, 32′, the underwater granulator 4′, the plant control 100′ and so on, can (but have not compulsory to) form a part of a plant 1 according to the present invention. In this specific respect, the person skilled of the art understands that the above given description of single components installed in a plant 1′ known from the state of the art as well as their principles of function, form also a respective part of the description of the present invention.

The manner of operation of the underwater granulator 4′ is described with the help of FIG. 2a and FIG. 2b, respectively. FIG. 2a is a schematic illustration showing the essential features of an under water granulator 4′ and its basic principals of function. FIG. 2b shows a preferred embodiment according to FIG. 2a. It shall be explicitly noted again, that a granulator 4′ as well known from the state of the art can also be particularly advantageously be used in a plant according with the present invention.

The impregnated melt F′ is granulated in a mechanical apparatus 4′ which is for example an underwater granulator 4′ driven by a motor 400′. It first passes through a distributor 404′ (which forms the inlet of the granulator 4′) to a nozzle plate 405′, with the melt being extruded through the nozzles 4051′ of the nozzle plate 405′. An additional feed means at the inlet, namely a screw conveyor 407′, is optional. A plurality of nozzles 4051′ is arranged in ring-like manner on the nozzle plate 405′. The plastic strands escaping from the nozzles 4051′ enter a chamber 403′ filled with water (or with another liquid) where the extruded material is brought into the form of granulate by a comminution with rotating knives 404′. The knives 404′ sit on a holder which is arranged on a shaft 600′ leading to the motor 4000′. The water is directed by a pump 40′ through an inlet connection 401′ under an elevated pressure (for example 10 bar) into the chamber 403′ from which it flushes the granulate G′, with simultaneous cooling of the granulate G′, into a separating apparatus 411′ via outlet stubs 402′. The granulate G′ is separated from water in the separating apparatus 411′ and discharged into the container C′. The water flows through a cooling apparatus 412′ in which it gives off the heat taken up from the freshly produced granulate G′ into the environment. If the water pressure in the separating apparatus 411′ is reduced to ambient pressure, then the water pump 40′ is arranged upstream before the cooling apparatus 412′. If a brine is used instead of water for example, the cooling of the granulate G′ can be carried out at lower temperatures (<0° C. for example).

The aforementioned state of the art has some drawbacks, in particular drawbacks related to the granulator. As already explained, regarding the production of granulates, in particular of micro-granulates, using a granulator, especially an under water granulator, a nozzle plate is used having nozzles with very small opening diameters. Thereby, some problems can arise in connecting with these nozzle plates when starting the granulator. Among other things, a freezing-off of the openings can occur, or due to the presence of an expanding agent or an other additive such as a nucleation means can lead to an excessive foaming may and/or to a an excessive degradation in case of stationary material within the pipes while temporary standstill of the plant, in particular if temperature sensitive additives are used, for example such as flame retardants. Regarding plants of from the prior art, for example as described above, first the components of the plant have to be scavenged in such cases, in order to be prepared to receive new additive-free material. But this procedure leads to a significant loss of material and a standstill of the plant or a conglomeration of material of the product, which does not comply with the required specifications. In case of plants with high throughput regarding plants requiring the operation of a plurality of granulators in parallel, the aforementioned procedure is not feasible. This is particularly a great problem in the case that the dosing of the additive is centrally carried out and the impregnated melt is distributed to a plurality of granulators. If a particular granulator is out of order because of a failure and, thus, has to be restarted and in many cases the entire plant has firstly to be operated with an additive-free melt. It goes without saying, that such a procedure is extremely ineffective, time consuming and as a result extremely costly.

Starting from the prior art it is therefore an object of the invention to make available a new plant for the continuous manufacture of an expandable plastic granulate avoiding the aforementioned problems known from the respective plants from the prior art as well as a method for running a plant and for the continuous manufacture of an expandable plastic granulate.

The subjects of the invention satisfying these objects are characterized by the features of independent claims 1 and 15. The dependent claims relate to particularly advantageous embodiments of the invention.

Thus, the invention relates to a plant for the continuous manufacture of an expandable plastic granulate. The plant includes a plastic melt source for providing a plastic melt, an impregnating device for providing an impregnated plastic melt by impregnating the plastic melt with an expanding agent provided by an expanding agent source, and a granulator for producing the granulate from the impregnated plastic melt with the granulator, with the granulator being fluidly connected to the impregnating device. According to the invention, a switching means is provided in such a way, that the plastic melt can be fed to the granulator under bypassing the impregnating device.

That is, the invention relates in particular to a new arrangement of the components of the prior art and connecting them by a switching means, so that a direct feeding of an additive-free melt to one or a plurality of granulators is rendered possible. In this respect, it is important that a dead-volume being as small as is achieved, in which dead-volume the melt is “at rest” in normal operation. According to the invention, in contrary to the state of the art, the part of the plant in which the additive is added to the melt, is constituted as a so called “loop”. The additive-free melt is first led directly past the granulators before it is fed into the mixer, which is for example a static mixer, for adding or impregnating the additives. In a special embodiment, via a valve, which is in particular a multi way valve, the granulators are connected both to an input pipe providing the additive-free melt as well as to an product pipe for piping the additive-free melt to the granulators.

Regarding a special embodiment, the melt pipe coming from the melt source, is connected via the switching means, which is in a simple embodiment a T-fitting, both to the multi way valve and to the mixing device, which can be the impregnating device, so that the melt, in particular a polymer melt, especially a polystyrene melt, can be fed directly to the granulators and/or to the mixing device depending on the operation conditions.

Particularly advantageously, the additive-free and/or the additive impregnated melt can be provided independently to every single granulator. A fast switching during operation the plant renders it possible to start every single granulator independently from the other granulators, for example with the additive-free melt and then switching into the production mode using the additive impregnated polymer melt, having the advantage that the other granulators can be independently and continuously operated so that, as a result, the operational reliability is significantly increased.

In case that a granulator fails due to technical reasons, it is decoupled from the impregnating device and the pipe from the valve to the respective granulator can be scavenged free using the additive-free melt from the melt source in order to avoid a deposition and a degradation of the product within the hot pipes during the standstill of the respective part of the plant.

A further important advantage of the present invention is that because of the possibility of the direct feeding of the additive-free melt to the granulator by evading the process step of adding the additive, it is also possible to granulate the plastic melt being not yet impregnated. Thus, using a plant according to the present invention, it is also possible to produce for example crystal-clear polystyrene granulate instead of expandable polystyrene, which is often abbreviated as EPS.

The concrete design of the valve can be different. In a first embodiment, the valve is a valve combined of several switches, for example a so called “Diverter Valve”, that is a valve having perpendicularly guided pistons with two or more piston positions. Or it is in an other embodiment a compact multi-way valve. Thereby, it is in particular important to avoid dead volumes or to at least to reduce dead volumes to an absolute minimum. If not, it must be expected that the polymer melt, in particular if it is impregnated with an temperature sensitive additive, will decompose within these dead volumes resulting a reduced product quality or leading to a corrosion within respective parts of the plant.

A plat according to the invention can be particularly advantageously used if the manufacturing capacity of the plastic melt source is a multiple of the capacity of a single granulator. As a rule, the under water granulators for producing micro-granulates are limited with respect of their manufacturing capacity, so that for the processing of a great amount of plastic melt a plurality of granulators must be operated in parallel. In such cases it is particularly important that the single granulators are not affected by each other in case that one of them should fail. This is achieved by leading the product stream from the melt source at least partly not trough the part of the plant in which the impregnating of the plastic melt is carried out, but feeding a respective part of the product stream from the melt source directly to the granulator. Regarding this, an additional granulator can be provided to render it possible to start the additional granulator via the switching means or a the valve, respectively, in case that another granulator fails. In order to realize such a operation mode, it is necessary to branch off a part stream from the melt source by means of the switching means.

Regarding a special embodiment of the invention, the additional granulator is a so called “stand-by granulator” including a nozzle plate having nozzles with openings of an equal or an enlarged diameter with respect to the diameter of the nozzle opening used in the other granulators for the production of the granulate. The stand-by granulator can, if equipped with the same diameter of nozzle openings as the other granulator replace without delay and interruption of production a granulator that failed for any reason, if connected to receive impregnated plastic melt through the switching means, avoiding any loss. Alternatively, if the stand-by granulator is equipped with larger nozzle openings, may produce non impregnated granulate, that can be either recycled to the plant or sold as commercial grade non-expandable polymer, such avoiding any loss of material. In a special embodiment is the diameter of the nozzle openings of the stand-by granulator for example up to 2 mm or lager. The enlarged openings ensure that even if for example particle like contaminations, for example “black spots” or agglomerates of solid additives are present within the polymer melt, the stand-by granulator can easily be started without problems. It may be designed to handle a larger flow rate than the other granulators.

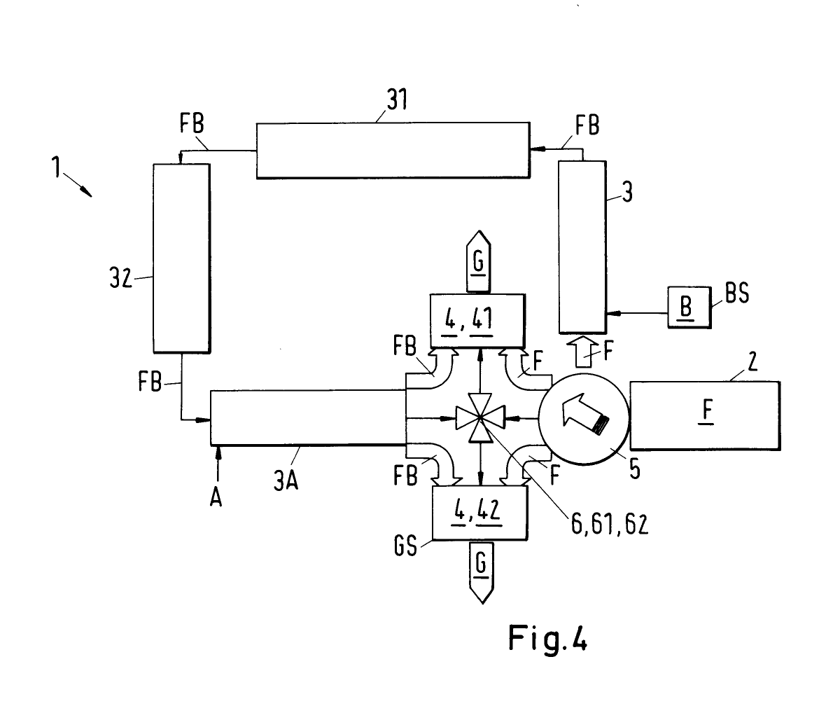

In very special cases a plant in accordance with the invention can be designed by arranging its components in a linear manner as in principle shown in FIG. 1 and not in a “loop” as described above and schematically shown in FIG. 4. In case that a plant according to the invention is arranged in a linear manner, a bypass means, in particular in form of a bypass pipe is provided allowing to by pass the impregnating device and/or the pre-treatment devices. In case that a by-pass is used, it is particularly advantageous to take appropriate measures to minimize the dead volume and/or the time of residence of the melt within the by-pass pipe.

Regarding a special embodiment of the present invention, the plastic melt can be fed to the impregnating device and/or to the granulator, in particular alternatively to the impregnating device or the granulator.

In particular for processing a greater amount of plastic melt in parallel at the same time, at least a first granulator and a second granulator is provided, wherein advantageously a first distributing means is provided in such a way, that the plastic melt can be fed to the first granulator and/or to the second granulator.

Regarding a further embodiment, a second distributing means is provided in such a way, that the impregnated plastic melt can be fed to the first granulator and/or to the second granulator alternatively or at the same time depending on the operation state of the plant.

Preferably, the first distributing means and/or the second distribution means is a multi-way valve being arranged and designed in such a way, that the plastic melt and/or the impregnated plastic melt can be fed to the first granulator and/or to the second granulator.

Particularly advantageously, a standby-granulator is additionally provided, wherein the first granulator and/or the second granulator and/or the standby-granulator is an under water granulator and/or an under water strand pelletizer and/or a strand pelletizer and/or a water ring pelletizer.

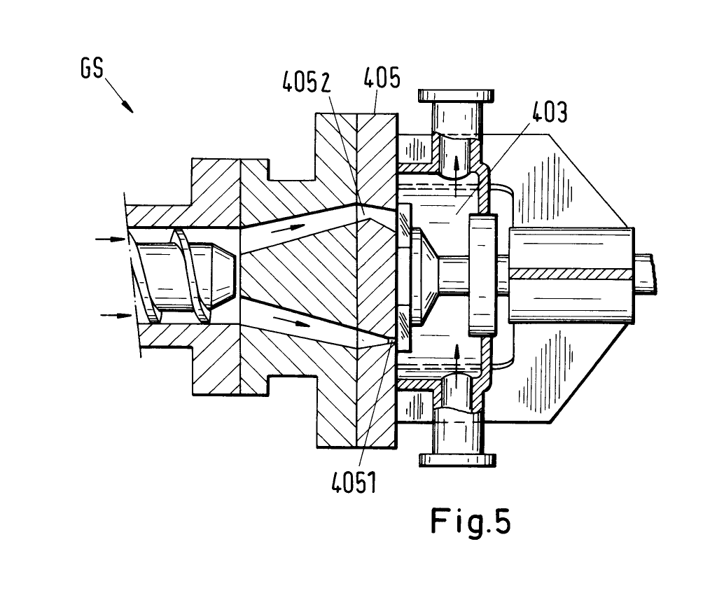

As shown in FIG. 2b and FIG. 5, the first granulator and/or the second granulator and/or the standby-granulator includes a receiving chamber and an extruding chamber being separated by a nozzle plate having a plurality of nozzle openings being arranged on the nozzle plate in such a way that, a plastic strand of plastic melt and/or impregnated plastic melt can be extruded from the receiving chamber into the extruding chamber.

Preferably, the diameter of a nozzle opening of the granulator and/or of the stand-by granulator is larger than the diameter of the nozzle opening of the first granulator and/or of the second granulator.

Regarding a further embodiment of the invention which is very important in practice, a pre-treatment device and/or an additive impregnating device is provided, and/or the impregnating device and/or the pre-treatment device, and/or the additive impregnating device includes a mixer and/or a cooler and or an extruder, in particular a dynamic extruder for mixing and/or cooling the plastic melt and/or the impregnated plastic melt.

Thereby, the impregnating device and/or the pre-treatment device and/or the additive impregnating device may include a static mixer as a contacting and homogenising apparatuses and the static mixer can especially be designed as a cooling device, in particular designed as a heat exchanger tube.

In most cases in practice, a source for an additive is fluidly connected to the plant, in particular to the additive impregnating device, in some cases to the impregnating device and/or to the pre-treatment device for adding in the operation state the additive to the plastic melt and/or the impregnated plastic melt.

In a very special embodiment, a bypass means is additionally provided for bypassing the impregnating device and/or the pre-treatment device and/or the additive impregnating device, in particular in case that the components of the plant according to the invention are arranged in linear instead in form of a loop.

The invention relates in addition to a method for running a plant in accordance with the invention as well as to a method for producing a granulate using a plant according to the invention.

The invention will be explained more closely in the following with the help of the schematic drawings which show:

FIG. 1 an example for a plant as known from the state of the art;

FIG. 2a an under water granulator in a schematic illustration;

FIG. 2b a special embodiment according to FIG. 2a

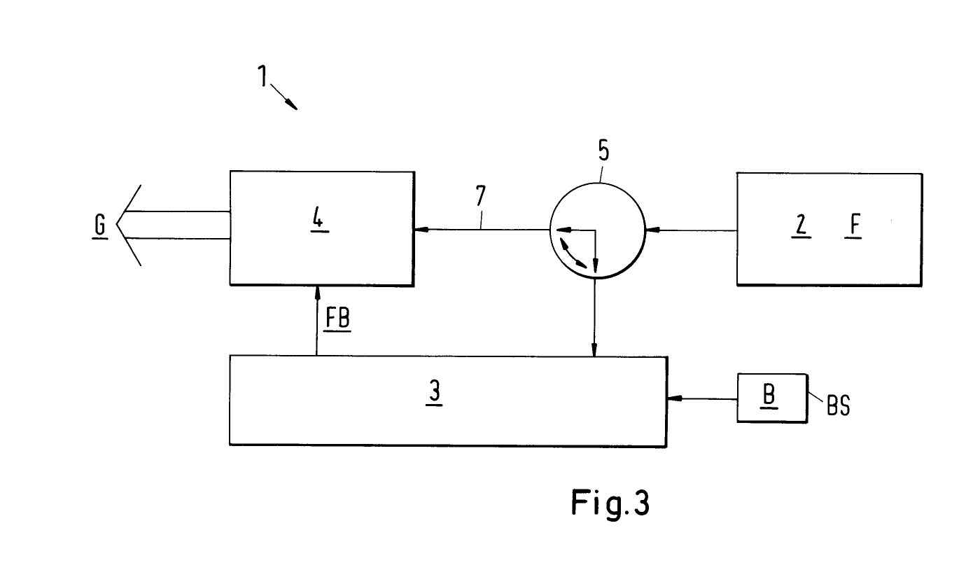

FIG. 3 a first embodiment of a plant according to the invention;

FIG. 4 a second embodiment of a plant according to the invention;

FIG. 5 an embodiment of a standby-granulator of the invention.

FIG. 1, FIG. 2a, and FIG. 2b display examples of a plant and an under water granulator, respectively, as known from the state of the art. As already mentioned, for the delineation of the prior art from the present invention, those features which relate to a plant or to components of a plant known from the prior art are provided with a dash, whereas the features in accordance with the invention are designated by reference numerals without a dash.

Regardless that the reference numerals in FIG. 1, FIG. 2a, FIG. 2b have a dash, any single component the plant 1′ of FIG. 1, in particular for example the plastic source 2′, the pressure producing feed apparatus 200′, the homogenising apparatus 3, the coolers 31′, 32′, the underwater granulator 4′, the plant control 100′ and so on, can (but have not compulsory to) form a part of a plant 1 according to the present invention. In this specific respect, the person skilled of the art understands that the above given description of single components installed in a plant 1′ known from the state of the art as well as their principles of function, form also a respective part of the description of the present invention. As also already mentioned, it shall be noted that a granulator 4′ as well known from the state of the art and described with the help of the FIG. 2a and FIG. 2b can also be particularly advantageously be used in a plant according with the present invention.

Since FIG. 1, FIG. 2a and FIG. 2b have been already discussed above in great detail, the description of the drawings is carried on with FIG. 3.

FIG. 3 shows in a schematic illustration a first embodiment of a plant 1 for the continuous manufacture of an expandable plastic granulate G starting with a plastic melt F, which is in the present example a polystyrene.

The plant 1 according to FIG. 1 includes a plastic melt source 2 for providing a plastic melt F, an impregnating device 3 for providing an impregnated plastic melt FB by impregnating the plastic melt F with an expanding agent B provided by an expanding agent source BS. In the present example the expanding agent may be any known expanding or blowing agent known from the state of the art, in particular H₂O, CO₂, N₂, a low boiling hydrocarbon, in particular pentane. A granulator 4 is also provided for producing the granulate G from the impregnated plastic melt FB with the granulator 4, 41, 42 being fluidly connected to the impregnating device 3. According to the invention a switching means 5 is provided in such a way, that the plastic melt F can be fed to the granulator 4 under bypassing the impregnating device 3. The switching means 5 may be for example a valve, in particular a multi-way valve 5 depending on the complexity of the plant 1, in particular depending on the number of granulators 4 used in the plant 1.

By FIG. 4, a second embodiment of a plant 1 according to the invention is displayed. The embodiment according to FIG. 4 is designed in form of a loop and very important in practice.

The plant 1 in form of a loop according to FIG. 4 includes a plastic melt source 2 for providing the plastic melt F, an impregnating device 3 for providing the impregnated plastic melt FB by impregnating the plastic melt F with an expanding agent B provided by an expanding agent source BS, as well as the granulator 4, 41, 42 for producing the granulate G from the impregnated plastic melt FB. The granulators 4, 41, 42 are fluidly connected to the impregnating device 3, wherein the granulator 42 is in a special embodiment of the invention a stand-by granulator GS. In accordance with the invention a switching means 5, which is in the present example simply a T-fitting 5 is provided in such a way, that the plastic melt F can be fed to the granulator 4 under bypassing the impregnating device 3 in case of a failure of the granulator 41. That is, the plastic melt F can be fed alternatively to the impregnating device 3 or to the granulators 4, 41, 42, GS.

As already mentioned and clearly shown in FIG. 4, a first granulator 41 and a second granulator 42, GS is provided producing the granulate G and the granulators 41, 42, GS being coupled via a first distributing means 6, 61, 62 to both the switching means 5 and the additive impregnating device 3A so that the plastic melt F can be fed to the first granulator 41 and/or to the second granulator 42, GS.

Regarding the special embodiment of FIG. 4, in addition the impregnating device 3 for adding the expanding agent B to the plastic melt F, two pre-treatment devices 31, 32 being subsequently arranged between the impregnating device 3 and the additive impregnating device 3A are provided as important components of the plant 1. The pre-treatment devices 31, 32 both include a mixer, in particular a static mixer, which mixer is at the same time a cooler for the cooling of the impregnated plastic melt FB.

Thereby, a source for an additive A is fluidly connected to the plant, in particular to the additive impregnating device 3A but may be in another embodiment also be connected to the impregnating device 3 and/or to the pre-treatment device 31, 32 for adding in the operation state the additive A to the plastic melt F and/or the impregnated plastic melt FB, respectively.

By FIG. 5 a special embodiment of a standby-granulator GS of the invention is displayed. The stand-by granulator GS according to FIG. 5 is essential identical to that described with the help of FIG. 2b.

The standby-granulator GS displayed by FIG. 5 is an under water granulator GS including a receiving chamber and an extruding chamber 403 being separated by a nozzle plate 405 having a plurality of nozzle openings 4051, 4052. The nozzle opening are arranged on the nozzle plate 405 in such a way that, a plastic strand of plastic melt F and/or a plastic strand of an impregnated plastic melt FB can be extruded from the receiving chamber into the extruding chamber 403.

The difference to the granulator 4′ displayed by FIG. 2b is that a diameter of at least one nozzle opening 4052 of the stand-by granulator GS is larger than a diameter of the nozzle opening 4051 of the first granulator 41 and/or of the second granulator 42, wherein in a preferred embodiment all nozzle openings of the stand-by granulator GS have a larger diameter than the nozzle openings 4051 of the granulators 4 being used for the production of the granulate G.

It is understood that apart from polystyrene, another thermoplastic polymer can also be used as a plastic melt, for example PLA. Examples are: styrene-copolymers, polyolefines, in particular polyethylene and also polypropylene or a mixture of these named substances.

H₂O, CO₂, N₂, a low boiling hydrocarbon, in particular pentane, or a mixture of the named substances can be used as an expanding agent. Diverse forms of granulate can be produced (depending on the cross-section of the nozzles, on the rotational speed of the knives and on the water pressure in the chamber. In particular, the granulate can be produced in the form of “pellets” or “beads” or as a partially foamed granulate.

1. A plant for the continuous manufacture of an expandable plastic granulate (G), the plant including a plastic melt source (2) for providing a plastic melt (F), an impregnating device (3) for providing an impregnated plastic melt (FB) by impregnating the plastic melt (F) with an expanding agent (B) provided by an expanding agent source (BS), and a granulator (4, 41, 42) for producing the granulate (G) from the impregnated plastic melt (FB) with the granulator (4, 41, 42) being fluidly connected to the impregnating device (3), characterized in that a switching means (5) is provided in such a way, that the plastic melt (F) can be fed to the granulator (4, 41, 42) under bypassing the impregnating device (3).

2. A plant in accordance with claim 1, that the plastic melt (F) can be fed to the impregnating device (3) and/or to the granulator (4, 41, 42), in particular alternatively to the impregnating device (3) or the granulator (4, 41, 42).

3. A plant in accordance with claim 1, wherein at least a first granulator (41) and a second granulator (42) is provided.

4. A plant in accordance with claim 3, wherein a first distributing means (61) is provided in such a way, that the plastic melt (F) can be fed to the first granulator (41) and/or to the second granulator (42).

5. A plant in accordance with claim 3, wherein a second distributing means (62) is provided in such a way, that the impregnated plastic melt (FB) can be fed to the first granulator (41) and/or to the second granulator (42).

6. A plant in accordance with claim 4, wherein the first distributing means (61) and/or the second distribution means (62) is a multi-way valve (6) being arranged and designed in such a way, that the plastic melt (F) and/or the impregnated plastic melt (FB) can be fed to the first granulator (41) and/or to the second granulator (42).

7. A plant in accordance with claim 1, wherein a standby-granulator (GS) is additionally provided.

8. A plant in accordance with claim 1, wherein the first granulator (41) and/or the second granulator (42) and/or the standby-granulator (GS) is an under water granulator and/or an under water strand pelletizer and/or a strand pelletizer and/or a water ring pelletizer.

9. A plant in accordance with claim 1, wherein the first granulator (41) and/or the second granulator (42) and/or the standby-granulator (GS) includes a receiving chamber and an extruding chamber (403) being separated by a nozzle plate (405) having a plurality of nozzle openings (4051, 4052) being arranged on the nozzle plate (405) in such a way that, a plastic strand of plastic melt (F) and/or impregnated plastic melt (FB) can be extruded from the receiving chamber into the extruding chamber (403).

10. A plant in accordance with claim 9, wherein a diameter of a nozzle opening (4052) of the granulator (41, 42) and/or of the stand-by granulator (GS) is larger than a diameter of the nozzle opening (4051) of the first granulator (41) and/or of the second granulator (42).

11. A plant in accordance with claim 1, wherein a pre-treatment device (31, 32) and/or a additive impregnating device (3A) for adding a additive to the plastic melt (F, FB) is provided, and/or wherein the impregnating device (3) and/or the pre-treatment device (31, 32) and/or additive impregnating device (3A) includes a mixer and/or a cooler and or an extruder, in particular a dynamic extruder for mixing and/or cooling the plastic melt (F) and/or the impregnated plastic melt (FB).

12. A plant in accordance with claim 1, wherein the impregnating device (3) and/or the pre-treatment device (31, 32) and/or the additive impregnating device (3A) includes a static mixer as a contacting and homogenising apparatus and wherein the static mixer is especially designed as a cooling device, in particular designed as a heat exchanger tube.

13. A plant in accordance with claim 1, wherein a source for an additive (A) is fluidly connected to the plant, in particular to the a additive impregnating device (3A) and/or to the impregnating device (3) and/or to the pre-treatment device (31, 32) for adding in the operation state the additive (A) to the plastic melt (F) and/or the impregnated plastic melt (FB).

14. A plant in accordance with claim 1, wherein a bypass means (7) is provided for bypassing the impregnating device (3) and/or the pre-treatment device (31, 32) and/or the additive impregnating device (3A).

15. A method for producing a granulate (G) using a plant (1) in accordance with claim 1.
